(19) United States
(12) Patent Application Publication
(10) Pub. No.: US 2006/0257288 A1
(43) Pub. Date: Nov. 16, 2006

(54) Hydrogen sulfide tolerant oxygen gas sensing device

(75) Inventors: Zhenhe Sun, Diamond Bar, CA (US); Vasu P. Narasimhan, Moreno Valley, CA (US)

Correspondence Address: KIRKPATRICK & LOCKHART NICHOLSON GRAHAM LLP, 535 SMITHFIELD STREET, PITTSBURGH, PA, 15222, US

(73) Assignee: Teledyne Technologies Incorporated

(21) Appl. No.: 11/120,452

(22) Filed: May 3, 2005

(51) Int. Cl. B32B 27/04; B32B 27/12; B32B 5/02; G01N 30/96; G01N 30/02

(52) U.S. Cl. 422/89; 422/88

(57) ABSTRACT

According to one aspect of the present disclosure, a hydrogen sulfide tolerant oxygen gas sensing device comprises a gas sensing portion including a gas inlet, a sensing electrode adjacent the gas inlet, a counter electrode, and an electrolyte contacting the sensing electrode and the counter electrode. The gas sensing device also includes a filter portion including a porous hydrogen sulfide gas removal medium. The hydrogen sulfide filter portion is disposed adjacent the gas inlet of the gas sensing portion and defines a gas flow pathway to the gas inlet, through the porous hydrogen sulfide gas removal medium.

### BACKGROUND OF THE TECHNOLOGY

1. Field of Technology

The present disclosure relates to oxygen gas sensing devices that are adapted to tolerate the presence of a gas in the gas stream to be sensed that can harm and reduce the useful service life of conventional gas sensing devices. More particularly, the present disclosure relates to trace and other types of oxygen gas sensing devices that are adapted to tolerate hydrogen sulfide (H₂S) gas in the gas to be sensed, a gas that can harm and reduce the useful service life of conventional gas sensing devices.

2. Description of the Background of the Technology

Gas sensors for measuring concentrations of oxygen or other gases often are used for detecting target gases in gas streams including gases that can harm or otherwise reduce the useful service life of the gas sensors. One such application of gas sensors is for monitoring trace concentrations of oxygen in natural gas at the well head, in the gas transmission lines, or at the gas processing plant. Oxygen monitoring is critical to safe operation of natural gas production plants since oxygen presents explosion and corrosion hazards if not closely monitored and controlled.

Biogenic and thermogenic reactions at various underground depths help produce underground natural gas reserves. As byproducts to these processes, “sour” gases such as hydrogen sulfide also are produced. Table 1 shows a typical composition of natural gas at the wellhead and indicates that up to 5% by volume of the natural gas is hydrogen sulfide gas.

TABLE 1
Typical Natural Gas Composition

| Gas Component | Concentration (%) |
|---|---|
| Methane (CH₄) | 70-90 |
| Ethane (C₂H₆) | 0-20 |
| Propane (C₃H₈) | |
| Butane (C₄H₁₀) | |
| Carbon Dioxide (CO₂) | 0-8 |
| Oxygen (O₂) | 0-0.2 |
| Nitrogen (N₂) | 0-5 |
| Hydrogen Sulfide (H₂S) | 0-5 |
| Rare Gases (Ar, He, Ne, Xe, etc.) | trace |

The hydrogen sulfide content in natural gas poses a substantial challenge to monitoring oxygen content because the hydrogen sulfide gas poisons the sensing electrode and reduces the useful service life of conventional electrochemical oxygen sensors, and sensors can fail after a relatively short time period if hydrogen sulfide gas is present in the sensed gas stream. The conventional manner for addressing this problem has been to remove the hydrogen sulfide gas from the monitored gas stream sent to the sensor using separate, external hydrogen sulfide scrubbers. For example, oxygen gas analyzers including, for example, the TELEDYNE® (Los Angeles, Calif.) Models OT-2 and OT-3 trace oxygen monitoring systems and 3000 Series oxygen analyzers, have included separate hydrogen sulfide scrubbers that remove substantially all hydrogen sulfide from the gas stream brought in contact with the sensor so that the sensor is exposed to an essentially hydrogen sulfide-free gas. An example of one such hydrogen sulfide scrubber is the TELEDYNE® TRANSCRUB™ transparent hydrogen sulfide scrubber.

Hydrogen sulfide scrubbers typically are bulky, requiring that the gas analyzers in which they are mounted be made correspondingly large. Perhaps more significantly, hydrogen sulfide scrubbers increase the internal volume of gas sampling systems and typically require use of relatively low gas flow rates, thereby increasing the response time of the analyzers. The scrubbers also must be maintained and periodically replaced to ensure that hydrogen sulfide gas is not passing through the scrubber to the sensor.

Accordingly, there is a need for oxygen gas sensors and oxygen gas sensing equipment that will not be significantly adversely affected by the presence of hydrogen sulfide gas in natural gas or other background gases. There also is a need for oxygen gas sensing devices useful in, for example, natural gas applications, that do not require use of an external scrubber to remove hydrogen sulfide gas from the gas stream before the gas stream is introduced to the gas sensor.

### SUMMARY

In order to address the need noted above, according to one aspect of the present disclosure, a hydrogen sulfide tolerant oxygen gas sensing device is provided comprising a gas sensing portion including a gas inlet, a sensing electrode adjacent the gas inlet, a counter electrode, and an electrolyte contacting the sensing electrode and the counter electrode. The gas sensing device also includes a filter portion including a porous hydrogen sulfide gas removal medium. The hydrogen sulfide filter portion is disposed adjacent the gas inlet of the gas sensing portion and defines a gas flow pathway to the gas inlet, through the porous hydrogen sulfide gas removal medium.

In certain non-limiting embodiments of the hydrogen sulfide tolerant oxygen gas sensing device according to the present disclosure, the hydrogen sulfide gas removal medium includes at least one material selected from activated carbon, copper compounds, metal oxides, and alkaline materials. In certain non-limiting embodiments, the hydrogen sulfide gas removal medium comprises a particulate hydrogen sulfide gas removal material disposed on at least one substrate. The substrate may be selected from, for example, activated carbon, silica gel, porous plastic, and activated carbon cloth.

In certain non-limiting embodiments of the oxygen gas sensing device according to the present disclosure, the gas sensing portion of the gas sensing device includes a gas sensor housing holding the electrolyte, and the filter housing is secured to the gas sensor housing. In certain of these embodiments, the filter housing is secured to the gas sensor housing by, for example, one of an adhesive and an adhesive tape. In other non-limiting embodiments of the oxygen gas sensing device according to the present disclosure, the gas sensing portion includes a gas sensor housing holding the electrolyte, and the gas sensor housing and the filter housing are portions of a single part.

According to another aspect of the present disclosure, a hydrogen sulfide tolerant electrochemical oxygen gas sensing device is provided comprising a gas sensing portion and a filter portion. The gas sensing portion includes a sensor housing and a gas inlet. A sensing electrode, a counter electrode, and an electrolyte in contact with the sensing electrode and the counter electrode are disposed within the sensor housing. The filter portion includes a filter housing and a porous hydrogen sulfide gas removal medium disposed in the filter housing portion. The porous hydrogen sulfide gas removal medium includes at least one hydrogen sulfide gas removal material selected from activated carbon, copper compounds, metal oxides, and alkaline materials. The filter housing portion is either mounted to or integral with the sensor housing portion and defines a gas flow pathway that passes through the porous hydrogen sulfide gas removal medium to the gas inlet. In certain non-limiting embodiments of the hydrogen sulfide tolerant electrochemical oxygen gas sensing device, the hydrogen sulfide gas removal material is disposed on a substrate selected from activated carbon, silica gel, porous plastic, and carbon cloth.

According to yet another aspect of the present disclosure, an electrochemical oxygen gas sensing device includes a housing defining a gas pathway through which gas to be sensed passes. The electrochemical oxygen gas sensing device further includes a hydrogen sulfide gas removal medium disposed in the gas pathway. In certain non-limiting embodiments of the electrochemical oxygen gas sensing device the hydrogen sulfide gas removal medium is capable of removing substantially all hydrogen sulfide gas from the gas to be sensed. Also, in certain non-limiting embodiments of the electrochemical oxygen gas sensing device, the gas sensing device also includes a sensor housing and a filter housing, wherein the hydrogen sulfide filter either is secured to the sensor housing, or is integral with the sensor housing such that the sensor housing and the filter housing are a single part.

According to yet an additional aspect of the present disclosure, a hydrogen sulfide gas filter is provided that is adapted to be attached to an oxygen gas sensor so as to render the oxygen gas sensor tolerant to the presence of hydrogen sulfide gas in the gas stream to be sensed by the oxygen gas sensor.

The reader will appreciate the foregoing details, as well as others, upon consideration of the following detailed description of certain non-limiting embodiments of devices and parts according to the present disclosure. The reader also may comprehend such additional advantages and details upon carrying out or using the devices and parts described herein.

### BRIEF DESCRIPTION OF THE DRAWINGS

The features and advantages of the devices and parts described herein may be better understood by reference to the accompanying drawing in which:

FIG. 1 is a perspective view of one non-limiting embodiment of a hydrogen sulfide tolerant oxygen gas sensing device constructed according to the present disclosure.

FIG. 2 is a sectional assembly view of one non-limiting embodiment of a filter subassembly of a hydrogen sulfide tolerant oxygen gas sensing device constructed according to the present disclosure.

FIG. 3 is a top view of a filter housing of the filter subassembly illustrated in FIG. 2.

FIG. 4 is a sectioned view of the filter subassembly illustrated in FIG. 2, showing the various components assembled.

FIG. 5 is a perspective view indicating a manner of attachment of the sensing subassembly and filter subassembly of one non-limiting embodiment of a hydrogen sulfide tolerant oxygen gas sensing device constructed according to the present disclosure.

FIG. 6 is a sectioned view of the oxygen gas sensing device constructed according to the present disclosure and including the filter subassembly shown in FIG. 4.

FIG. 7 is a schematic view of the test setup used in Examples 2 through 4 of the present disclosure.

FIGS. 8 and 9 are graphs depicting the relationship of zero offset and time (FIG. 7), and span and time (FIG. 8) for certain non-limiting embodiments of hydrogen sulfide gas tolerant oxygen gas sensing devices constructed according to the present disclosure.

### DESCRIPTION OF CERTAIN NON-LIMITING EMBODIMENTS

Other than in the operating examples, or where otherwise indicated, all numbers expressing measurements, quantities of ingredients, conditions, and the like used in the present description and claims are to be understood as being modified in all instances by the term “about”. Accordingly, unless indicated to the contrary, any numerical parameters set forth in the following description and the attached claims are approximations that may vary depending upon the desired properties one seeks to obtain in the devices and parts according to the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the present disclosure are approximations, the numerical values set forth in any specific examples herein are reported as precisely as possible. Any numerical values, however, inherently contain certain errors, such as, for example, operator errors and/or equipment errors necessarily resulting from the standard deviation found in their respective testing measurements. Also, it should be understood that any numerical range recited herein is intended to include the range boundaries and all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Certain non-limiting embodiments according to the present disclosure are directed to an oxygen gas sensing apparatus including means for removing substantially all of the hydrogen sulfide gas from the gas to be sensed before the gas to be sensed reaches the gas sensing portion of the gas sensing apparatus.

Following are examples illustrating certain aspects of non-limiting embodiments of certain oxygen gas sensing devices within the present disclosure. It will be understood that the following examples are merely intended to illustrate certain embodiments of the devices, and are not intended to limit the scope of the present disclosure in any way. It will also be understood that the full scope of the inventions encompassed by the present disclosure is better indicated by the claims appended to the present description.

According to an aspect of the present disclosure, an oxygen gas sensing device is provided that can tolerate the presence of certain concentrations of hydrogen sulfide gas in the gas stream to be sensed. The gas sensing device includes a sensing subassembly that detects the presence and/or concentration of the target gas. The gas sensing device also includes a filter subassembly defining a gas flow pathway and including a hydrogen sulfide gas removal medium that removes substantially all hydrogen sulfide gas from the gas stream passing to the sensing subassembly. Thus, the sensing subassembly is protected from hydrogen sulfide gas that may be entrained in the bulk gas or bulk gas steam.

The sensing subassembly may be modeled after or identical to, for example, electrochemical gas sensors having conventional designs. As is familiar to those having ordinary skill, electrochemical gas sensors essentially operate as transducers for determining the concentration of target gases in a bulk gas (such as the atmosphere) or a gas stream (such as natural gas flowing through a pipeline). Electrochemical gas sensors operate by reacting with the target gas and producing an electrical signal proportional to the target gas concentration. A typical electrochemical gas sensor includes a sensing electrode (also variously referred to in the art as a “working” or “measurement” electrode), and a counter electrode, separated and contacted by an electrolyte, which may be a suitably conductive liquid or solid. Gas that comes in contact with the sensor first passes through a hydrophobic gas permeable barrier, and then reaches the sensing electrode. At the sensing electrode, the target gas either is oxidized or is reduced. At the counter electrode a complementary reduction-oxidation half cell reaction occurs, and the repetition of the coupled half-cell reactions generates a current through an external circuit. The magnitude of the current is measured and is proportional to the target gas concentration. Because the manner of operation of electrochemical gas sensors is well known, further discussion is considered unnecessary in the present disclosure.

Non-limiting examples of commercially available conventional electrochemical oxygen gas sensors that may be used as the sensing subassembly in the gas sensing device of the present disclosure include TELEDYNE® types A2C, B2C, INSTA TRACE™ A2C, INSTA TRACE™ B2C, and L2C trace oxygen sensors, and types A5, B1, and B3 percentage oxygen sensors. Those having ordinary skill, after considering the present disclosure, may readily identify other commercially available gas sensors that may be used as the sensing subassembly in the oxygen gas sensing device of the present disclosure. Also, the present disclosure is not limited to retrofitting existing commercially available oxygen gas sensors with a hydrogen sulfide tolerance capability, but also includes oxygen gas sensing devices having sensing subassemblies that differ in design from existing electrochemical gas sensors. Also, certain embodiments of the gas sensing devices of the present disclosure may include a sensing subassembly housing that is a separate piece from the housing of the filter subassembly (such as in Example 1 below), or the housings may be incorporated into or regions of a single piece or component of the gas sensing device. Also, it will be apparent to those of ordinary skill that the hydrogen sulfide gas tolerance features taught by the present disclosure are not limited to application with existing gas sensor products or designs.

The filter subassembly of certain non-limiting embodiments of the oxygen gas sensing device of the present disclosure includes a filter housing that defines a gas flow pathway from a gas source, to which the filter subassembly may be connected, and the gas inlet region of the sensing subassembly. The filter housing includes at least one hydrogen sulfide gas removal medium, which is defined herein to refer to any element, compound, or material that suitably removes substantially all hydrogen sulfide gas from an oxygen-containing gas mixture when contacted by the gas mixture. As used herein, “substantially all hydrogen sulfide gas” means that the hydrogen sulfide gas concentration in the gas reaching the gas permeable hydrophobic membrane at the gas inlet of the sensing subassembly is not greater than 5 ppm when the filter subassembly is operating at optimum efficiency to remove hydrogen sulfide gas. The hydrogen sulfide gas removal medium also preferably can be disposed entirely within the filter subassembly in the gas flow pathway, and must allow gas flow around or through the hydrogen sulfide gas removal medium so that the gas contacts the removal medium. Thus, the gas flow pathway defined by the filter subassembly passes through or around the hydrogen sulfide gas removal medium and to the hydrophobic gas permeable membrane positioned at the gas inlet region of the sensing subassembly.

Examples of materials that may be suitable hydrogen sulfide gas removal media useful in embodiments of the oxygen gas sensing device of the present disclosure include, for example, copper compounds, metal oxides, alkaline materials, and suitable forms of activated carbon. Copper compounds, such as copper oxides, will react with hydrogen sulfide gas and form solid compounds that remain entrained within the filter medium. In addition to copper oxide, a large number of other metal oxides that are stable in air will react with hydrogen sulfide to form solid metal sulfides. Alkaline substances may be used to react with the acidic hydrogen sulfide gas and form precipitates that remain entrained within the filter medium. Many types of activated carbon would be suitable, although particulate forms allowing gas flow therethrough are preferred. In cases where the form of the removal medium is suitable, the medium may be mounted or encased within the filter housing without being mounted on any substrate. For example, the hydrogen sulfide gas removal medium may be copper oxide particles encased within a gas permeable canister, which is in turn mounted in the filter subassembly within the gas flow pathway. In other possible embodiments, the filter subassembly may include a substrate on which a material that removes hydrogen sulfide gas is disposed. For example, the removal medium may include a porous substrate impregnated with a particulate hydrogen sulfide gas removal material. Examples of possible substrates for hydrogen sulfide removal materials include activated carbon, silica gel, porous plastic, and activated carbon cloth. Thus, in one non-limiting embodiment of a gas sensing device according to the present disclosure, the hydrogen sulfide gas removal medium is one or more layers of a porous activated carbon cloth that has been impregnated with 5 to 15 weight percent of a powdered copper compound.

In all cases, a suitable type and quantity of the hydrogen sulfide gas removal medium must be included in the filter subassembly to reduce hydrogen sulfide content in the gas to be sensed to the desired maximum concentration. Of course, the desired application or range of applications of the gas sensing device may be taken into account when deciding on the type and quantity of hydrogen sulfide gas removal medium to include in the gas sensing device. Certain applications may require a more aggressive capability to deal with relatively high hydrogen sulfide gas concentrations without necessitating frequent replacement of the gas sensing device.

The foregoing description of possible hydrogen sulfide gas removal media necessarily offers only limited examples of possible media. Those having ordinary skill, upon considering the present disclosure, may be able to identify additional materials that could be included in the filter subassembly of the oxygen gas sensing devices according to the present disclosure and that would satisfactorily remove hydrogen sulfide gas from gas mixtures passing along the gas flow pathway through the hydrogen sulfide gas removal medium and to the gas inlet region of the sensing subassembly.

As discussed above, the gas sensing device of the present disclosure may include distinct filter and sensing subassemblies having distinct housings. The housings may be attached to provide the hydrogen sulfide gas tolerant gas sensing device. The technique used to attach the subassemblies may be any technique that suitably securely joins the subassemblies so that the gas flow pathway does not allow gas to leak at the interface between the subassemblies. Examples of suitable techniques for attaching the subassemblies include the use of adhesive compounds and double sided adhesive tapes. Given the possibility of these embodiments, one aspect of the scope of the present disclosure includes hydrogen sulfide gas tolerant gas sensing devices provided by suitably attaching a hydrogen sulfide gas filter of an appropriate design to an existing commercially available electrochemical gas sensor. By this technique, a gas sensor manufacturer, supplier, or user may “retrofit” an existing inventory of gas sensors to provide them with hydrogen sulfide gas tolerance capabilities absent the need for an external hydrogen sulfide scrubber.

An alternative to attaching together distinct filter and sensing subassemblies is to provide a single, one-piece housing or another single part on, to, or within which one or more component parts of each of the filter subassembly and the sensing subassembly are mounted. In such a design, the terms “filter subassembly” (or “filter portion”) and “sensing subassembly” (or “sensing portion”) are used herein to refer to the distinct individual components of the respective subassembly, along with that portion of the shared component or components associated with those individual components. For example, one non-limiting embodiment of the gas sensing device according to the present disclosure include a one-piece plastic housing in which are mounted or which contains components including the hydrogen sulfide gas removal medium and the electrochemical cell components (for example, the sensing and counter electrodes, and the electrolyte). This may be accomplished by, for example, suitably molding or machining the unitary housing to include distinct and appropriately positioned and dimensioned compartments for the several distinct components of the two subassemblies. In such a design, the filter subassembly or filter portion refers to the distinct filter components, as well as that portion or part of the shared housing associated with those distinct filter components; and the sensing subassembly or sensing portion refers to the distinct sensing components, as well as that portion of the shared housing associated with those distinct sensing components.

Following are the intended definitions of certain terms used in the present description and claims.

As used herein, “gas flow pathway” and “gas pathway” refer to a pathway for a gas.

As used herein, the phrase “gas stream to be sensed” and the like refer to that portion of the bulk gas or bulk gas stream that is passed to the vicinity of the gas sensing device so that the concentration of the target gas can be sensed. In some cases, the entire bulk gas or gas stream is passed to the vicinity of the gas sensing device, while in other cases only some fraction is passed to the vicinity of the gas sensing device.

As used herein, “hydrogen sulfide gas removal medium” refers to any material that, when contacted with a gas mixture including hydrogen sulfide gas, removes hydrogen sulfide gas therefrom, either by way of a chemical reaction between the hydrogen sulfide gas and the medium or some part of the medium, or by some other mechanism.

As used herein, “percent gas sensor”, “percent oxygen sensing device”, and the like refer to a gas sensing device designed to detect concentrations of a target gas wherein the target gas is present in concentrations of at least 1%.

As used herein, “target gas” refers to the particular gas that the gas sensing device is designed to detect.

As used herein, “trace gas sensor”, “trace gas sensing device”, and the like refer to a gas sensing device designed to detect concentrations of a target gas wherein the target gas is present in concentrations less than 1%.

Following are several examples illustrating certain aspects of non-limiting embodiments of hydrogen sulfide tolerant oxygen gas sensing devices according to the present disclosure. It will be understood that the following examples, although directed to only a limited number of possible embodiments within the scope of the present disclosure, are not intended to limit the scope of the appended claims.

### EXAMPLE 1

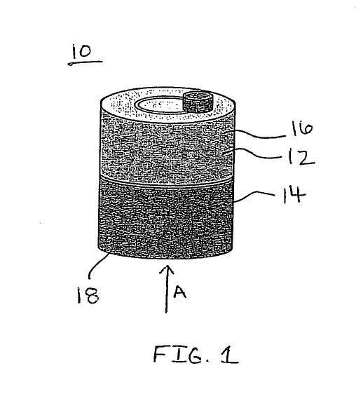

FIG. 1 schematically depicts in a perspective view one non-limiting embodiment of an oxygen sensing device 10 constructed according to the present disclosure. The device 10 includes a gas sensing portion or subassembly 12 and a filter portion or subassembly 14. The gas sensing subassembly 12 may be an electrochemical trace oxygen sensor having a conventional design. The gas sensing subassembly includes a sensor housing portion, such as cylindrical sensor housing 16 in FIG. 1. A sensing electrode, a counter electrode, and an electrolyte in contact with both electrodes are disposed within the sensor housing 16. In the present example, the gas sensing subassembly 12 is a TELEDYNE® type A2C oxygen sensor. The manner of operation of electrochemical gas sensors, such as the TELEDYNE® type A2C oxygen sensor, is well known and, therefore, is not described in any detail herein.

The filter subassembly 14 is secured to the gas sensing subassembly 12 in the vicinity of the gas inlet region of the gas sensing subassembly as described below. The filter subassembly 14 is appropriately secured to a gas source to be monitored by the gas sensing device. Gas to be sensed enters the filter subassembly 14 in the direction of arrow A in FIG. 1 and passes along a gas flow pathway defined within the cylindrical filter housing 18 of the filter subassembly 14. The gas flow pathway conveys the gas to be sensed to the gas inlet region of the gas sensing subassembly 12. A hydrogen sulfide gas removal medium is disposed within the filter subassembly 12, where it is in the gas flow pathway. Thus, the gas to be sensed passes through the hydrogen sulfide gas removal medium prior to reaching the gas inlet region of the gas sensing portion and is substantially devoid of hydrogen sulfide gas when it reaches the gas inlet region and enters the gas sensing subassembly 12.

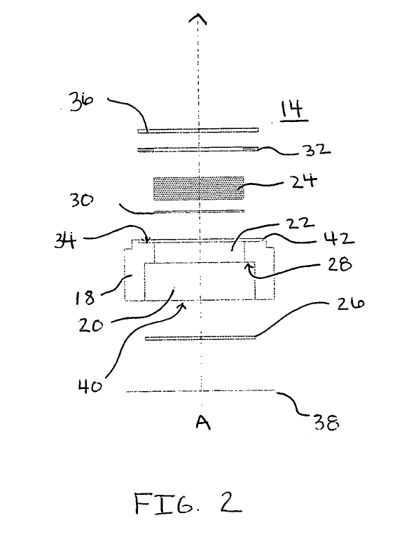

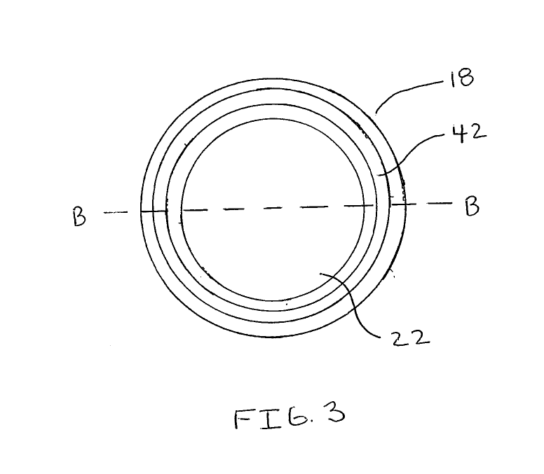

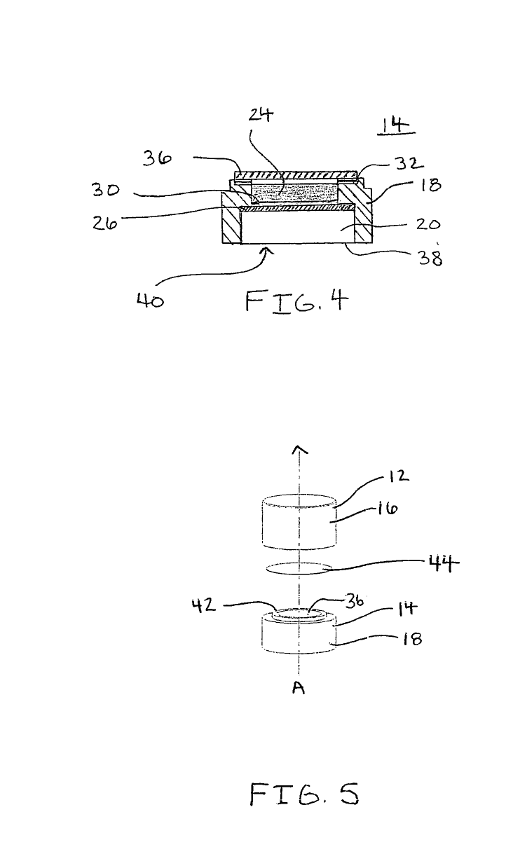

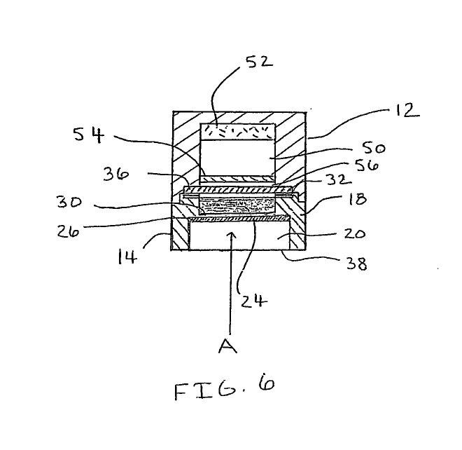

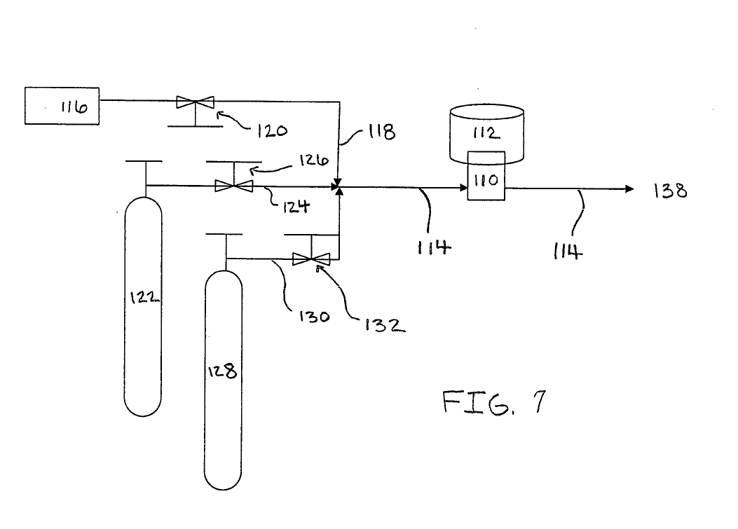

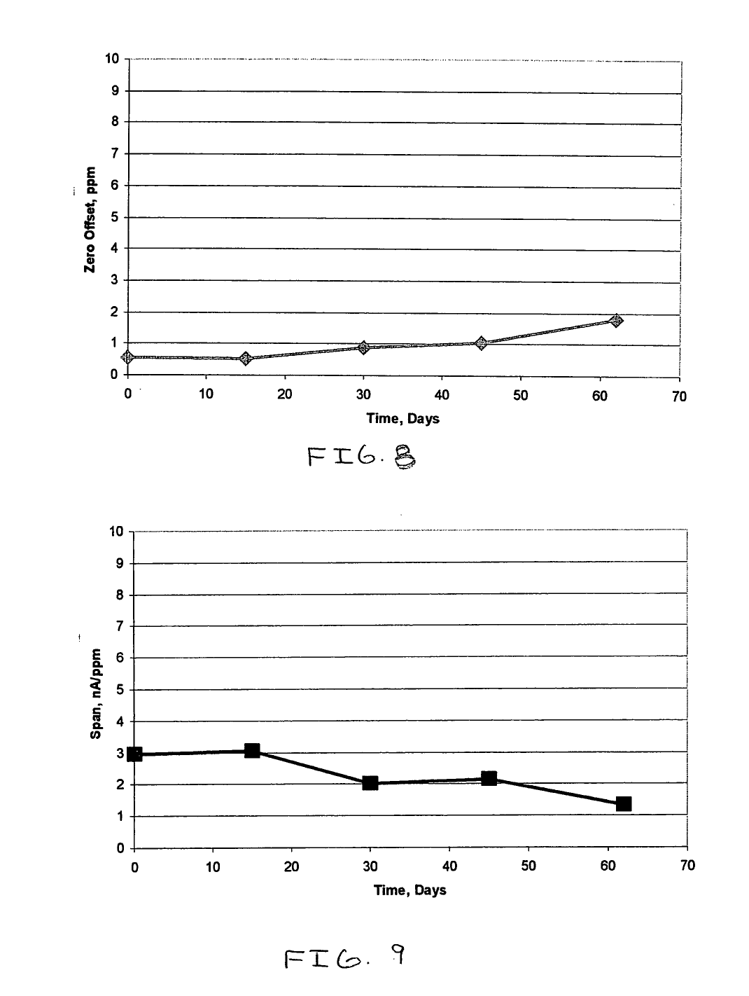

FIG. 2 is an exploded cross-sectional view through the filter subassembly 14 showing its several components. Filter housing 18, which may be, for example, an injection molded high density polyethylene part, includes continuous cylindrical filter void 20, which defines the gas flow pathway through the filter housing 18. FIG. 3 is a top view of filter housing 18, and line B-B indicates the point at which filter housing 18 and the other components of the filter subassembly 14 have been sectioned to provide FIG. 2. FIG. 4 is a cross-sectional view of the assembled sensing subassembly 14.

Referring again to FIG. 2, filter void 20 includes cylindrical removal medium void 22 in which is disposed hydrogen sulfide gas removal medium 24. The hydrogen sulfide gas removal medium 24 consists of a stack of six circular layers of copper oxide-impregnated activated carbon cloth. A suitable copper oxide-impregnated activated carbon cloth is ZORFLEX™ FM2/250 activated charcoal cloth, available from Charcoal Cloth International, a subsidiary of Calgon Carbon Corporation (Pittsburgh, Pa.). The ZORFLEX™ FM2/250 cloth comprises a 1/1 plain woven fabric having a thickness in the range of 0.4 to 0.6 mm and consisting wholly of activated charcoal fibers, with approximately 13 threads per centimeter (warp and weft), and which is impregnated with 9 to 15% w/w, nominally 12.5% w/w, of powdered copper oxide. As hydrogen sulfide gas passes through the porous removal medium 24 disposed in removal medium void 22, it reacts with the copper oxide to form solid copper sulfide, which is retained on the medium 24. In this way, hydrogen sulfide gas is removed from the flow of gas passing through the removal medium 24.

To retain the removal medium 24 within the removal medium void 22, a stainless steel mesh clamp 26 is interference fit into void 20 abutting circular first abutment surface 28. A porous PTFE filter disk 30 is interposed between the removal medium 24 and the mesh clamp 26. The PTFE filter disk 30 may be a ZITEX® PTFE disk, available from the Fluid Systems Division of Saint-Gobain Performance Plastics Corporation (Valley Forge, Pa.). The PTFE filter disk 30 acts as a depth filter and a screen, and inhibits small particulate matter entrained within the gas stream from entering the porous removal medium 24. One side of a double-sided adhesive ring 32 is adhered to circular second abutment surface 34, and stainless steel mesh clamp 36 is adhered to the second side of adhesive ring 32. Thus stainless steel mesh clamps 26 and 36 retain the removal medium 24 within the void 22, but allow gas that is to be sensed to freely pass through the filter subassembly 14. Non-gas permeable barrier disk 38 is adhered to filter housing 18 across filter gas inlet 40. The barrier disk 38 protects the oxygen sensor from oxygen exposure during storage and installation and may be removed prior to placing the gas sensing apparatus 10 in service. The barrier disk 38 may be, for example, a polyester adhesive tape, such as 3M® SUPER BOND™ 396 polyester film tape, available from 3M, Minneapolis, Minn.

As indicated in FIG. 5, the filter subassembly 14 is attached to the gas sensing subassembly 12 by disposing the circular flange 42 of the filter housing 18 within a complementary shaped void (not shown) defined at the gas inlet region of the sensing portion 12 by the sensor housing 16. It will be understood from FIG. 2 that the stainless steel mesh clamp 36 will be exposed on the surface of the filter portion 14 within the circular flange 42. A PTFE filter disk 44, such as a ZITEX® PTFE disk (see above), may be interposed between the filter subassembly 14 and the sensing subassembly 12 prior to attaching the subassemblies. A suitable adhesive compound or a double-sided adhesive tape secures the sensing subassembly 12 to the filter subassembly 14, thereby providing the hydrogen sulfide tolerant gas sensing device 10. Referring to FIGS. 1 and 2, gas to be sensed passes through the filter subassembly 14 of the gas sensing device 10 in the direction of arrow A. The gas passes through, in order, stainless steel mesh clamp 26, PTFE filter disk 30, removal medium 24, and stainless steel mesh clamp 36, and then into the inlet region of the sensing subassembly 12, where it enters that subassembly.

FIG. 6 is a cross-sectional view taken through the gas sensing device 10 with the sensing subassembly 12 attached to the filter assembly 14. Because the construction of the TELEDYNE® type A2C oxygen sensor used as the sensor subassembly 12 in the present example is known, only certain components of subassembly 12 are shown in FIG. 6. Those components are gas permeable hydrophobic membrane 56, sensing electrode 54, counter electrode 52, and electrolyte 50. As discussed above, gas to be sensed enters the filter subassembly 14 in the direction of arrow A, passes through the filter subassembly 14, and then enters sensing subassembly 14 through gas permeable hydrophobic membrane 56.

### EXAMPLES 2 THROUGH 4

The performance characteristics of an embodiment of a hydrogen sulfide tolerant oxygen gas sensing device constructed according to the present disclosure were evaluated. Several hydrogen sulfide tolerant gas sensing devices constructed according to the present disclosure were prepared by fitting TELEDYNE® type A2C oxygen sensors with experimental hydrogen sulfide filters as described in Example 1. The completed gas sensing devices were subjected to various gas mixtures including hydrogen sulfide gas. The test setup used is schematically shown in FIG. 7. Hydrogen sulfide tolerant gas sensing apparatus 110 was connected to a TELEDYNE® INSTA-TRANS™ oxygen transmitter 112 and installed on gas pathway 114. Nitrogen gas source 116 communicates with pathway 114 by pathway 118, which passes through valve 120. Cylinder 122 holds a gaseous mixture of 13.5 ppm oxygen gas, 2% by volume carbon dioxide gas, and balance methane gas. Cylinder 122 communicates with pathway 114 by pathway 124, which passes through valve 126. Cylinder 128 holds a gaseous mixture of 1000 ppm hydrogen sulfide gas, 2% by volume carbon dioxide gas, and balance methane gas. Cylinder 128 communicates with pathway 114 by pathway 130, which passes through valve 132. By suitably adjusting valves 120, 124, and 132, the gas sensing apparatus 110 was subjected to a desired mixture of gases. The bulk flow of gases passed from conduit 114 out to gas vent 138.

### EXAMPLE 2

Sensing characteristics of eight TELEDYNE® type A2C trace oxygen sensors (numbered 1 through 8) were evaluated. After this evaluation, each of the eight sensors was retrofitted with an experimental hydrogen sulfide filter as described in Example 1, to provide eight experimental oxygen gas sensing devices. The experimental devices were numbered 1X through 8X, wherein experimental device 1X was constructed using oxygen sensor 1, experimental device 2X was constructed using oxygen sensor 2, and so forth. Using the setup of FIG. 7, the eight experimental sensing devices were subjected to a flow of gas including hydrogen sulfide gas for 8 hours per day for 96 days. Thus, total exposure of each experimental sensing apparatus was 768 hours (32 days). Sensing characteristics of the experimental sensing devices were then determined. Table 2 lists the various characteristics measured prior to and after retrofitting the oxygen sensors with the filter subassemblies. The similarity between the listed characteristics before and after retrofitting demonstrates that the oxygen sensors' main oxygen gas sensing characteristics were not significantly affected by retrofitting the hydrogen sulfide gas filter subassemblies to the sensors.

TABLE 2
Test Results

| | Span −8.1 | nA | Offset | Offset | Response |
|---|---|---|---|---|---|
| Sensor | ppm (nA) | (ppm) | (nA) | (ppm) | time (sec.) |
| 1 | 28.23 | 3.49 | 1.19 | 0.34 | 30 |
| 2 | 28.72 | 3.55 | 1.85 | 0.52 | 28 |
| 3 | 27.55 | 3.40 | 1.3 | 0.38 | 26 |
| 4 | 28.63 | 3.53 | 1.38 | 0.39 | 26 |
| 5 | 27.03 | 3.34 | 1.45 | 0.43 | 28 |
| 6 | 28.01 | 3.46 | 1.22 | 0.35 | 30 |
| 7 | 27.99 | 3.46 | 1.76 | 0.51 | 28 |
| 8 | 28.35 | 3.50 | 1.24 | 0.35 | 26 |
| 1X | 28.02 | 3.46 | 1.54 | 0.45 | 23 |
| 2X | 28.28 | 3.49 | 3.46 | 0.99 | 19 |
| 3X | 49.41 | 6.10 | 2.48 | 0.41 | N/A |
| 4X | 21.76 | 2.69 | 2.06 | 0.77 | 20 |
| 5X | 24.96 | 3.08 | 2.06 | 0.67 | 20 |
| 6X | 30.04 | 3.71 | 3.45 | 0.93 | 17 |
| 7X | 25.76 | 3.18 | 1.54 | 0.48 | 19 |
| 8X | 24.93 | 3.08 | 1.07 | 0.35 | 20 |

### EXAMPLE 3

Four hydrogen sulfide tolerant trace oxygen gas sensing devices constructed according to Example 1 and numbered 9X through 12X were prepared and exposed to a flow of nitrogen gas including 1000 ppm hydrogen sulfide gas using the test setup of FIG. 7. Each experimental device was exposed to the gas flow for 20 days (480 hours), and then removed from the setup and tested for zero offset and span response. Each device was then re-mounted to the test setup, exposed to the hydrogen sulfide-containing gas flow for an additional 14 days (336 hours), and then re-tested for zero offset and span response. The results of the tests are shown in Table 3.

TABLE 3
Test Results

| | | |
|---|---|---|
| Current (nA) | Zero Offset | Sensitivity |

| | | | | |
|---|---|---|---|---|
| Sensor No. | Zero | Span | (ppm) | (nA/ppm) |

Tested After 20 Days

| | | | | |
|---|---|---|---|---|
| 9X | 0.90 | 25.55 | 0.30 | 3.04 |
| 10X | 1.95 | 25.63 | 0.67 | 2.92 |
| 11X | 2.08 | 24.56 | 0.75 | 2.77 |
| 12X | 2.20 | 28.07 | 0.69 | 3.19 |

Tested after 34 Days (Total)

| | | | | |
|---|---|---|---|---|
| 9X | 1.05 | 23.06 | 0.38 | 2.79 |
| 10X | 3.14 | 22.18 | 1.30 | 2.41 |
| 11X | 2.52 | 24.36 | 0.91 | 2.76 |
| 12X | 2.68 | 25.09 | 0.94 | 2.84 |

The current and zero offset data shown in Table 3 derived after 20 days is similar to the data shown in Table 2 derived from testing the unmodified trace oxygen sensors in Example 1. This indicates that the hydrogen sulfide gas filter subassemblies of Sensor Nos. 9X-12X protected the sensing subassemblies from any significant damage by the hydrogen sulfide gas. Table 3 reveals an increase in zero offset and a reduction in sensitivity between 20 and 34 days. This suggests that after extensive exposure to hydrogen sulfide gas, the hydrogen sulfide gas removal medium used in Sensor Nos. 9X-12X was becoming exhausted and allowing some significant concentration of hydrogen sulfide gas to reach the sensing subassemblies. A more detailed study would reveal the optimal service life of the hydrogen sulfide tolerant sensing devices under the conditions to which they were subjected in the testing.

### EXAMPLE 4

Ten TELEDYNE® type A2C oxygen sensors, numbered 13 through 22, were tested for various sensing characteristics. The sensors were then used to produce ten hydrogen sulfide tolerant gas sensing devices according to the procedure of Example 1. The experimental devices were then tested for the same sensing characteristics. The test data revealed that important sensing characteristics of the oxygen sensors were not affected by retrofitting the sensors with the hydrogen sulfide gas filter subassemblies.

Eight of the experimental devices were further evaluated by being continuously exposed to a nitrogen gas stream including 100 ppm hydrogen sulfide gas. Each of these experimental sensing devices was tested for zero offset and span response every other week for an extended period. The average results derived from testing the eight devices are plotted in the graphs shown in FIG. 8 (zero offset as a function of time) and FIG. 9 (span as a function of time). The graphs suggest that both zero offset and span remained relatively constant during the initial two-week period. Thereafter, measured zero offset increased over time, and span generally decreased over time. Thus, the plotted data suggests that the filter subassemblies effectively protected the oxygen sensors from the affects of the hydrogen sulfide gas early on and then, as the hydrogen sulfide gas removal medium became exhausted, hydrogen sulfide gas was passed to the sensors, and the sensors' gas sensing properties deteriorated.

As noted herein, the specific examples described herein should not be considered to limit the breadth of the following claims. For instance, the hydrogen sulfide tolerant gas sensing devices according to the present disclosure may take a variety of forms not specifically mentioned herein. Although the foregoing description has necessarily presented a limited number of embodiments of the invention, those of ordinary skill in the relevant art will appreciate that various changes in the components, compositions, details, materials, and process parameters of the examples that have been herein described and illustrated in order to explain the nature of the invention may be made by those skilled in the art, and all such modifications will remain within the principle and scope of the invention as expressed herein and in the appended claims. It will also be appreciated by those skilled in the art that changes could be made to the embodiments described above without departing from the broad inventive concept thereof. It is understood, therefore, that this invention is not limited to the particular embodiments disclosed, but it is intended to cover modifications that are within the principle and scope of the invention, as defined by the claims.

We claim:

1. A hydrogen sulfide tolerant oxygen gas sensing device comprising:
a gas sensing portion including a gas inlet, a sensing electrode adjacent the gas inlet, a counter electrode, and an electrolyte contacting the sensing electrode and the counter electrode; and
a filter portion including a porous hydrogen sulfide gas removal medium, the hydrogen sulfide filter portion adjacent the gas inlet of the gas sensing portion and defining a gas flow pathway to the gas inlet through the porous hydrogen sulfide gas removal medium.

2. The oxygen gas sensing device of claim 1, wherein the filter portion includes a filter housing, wherein the porous hydrogen sulfide gas removal medium is disposed in the gas flow pathway within the filter housing.

3. The oxygen gas sensing device of claim 2, wherein the porous hydrogen sulfide gas removal medium comprises at least one material selected from the group consisting of activated carbon, copper compounds, metal oxides, and alkaline materials.

4. The oxygen gas sensing device of claim 3, wherein the porous hydrogen sulfide gas removal medium comprises one of: a particulate hydrogen sulfide gas removal material sealed within the filter housing; and a porous substrate impregnated with a particulate hydrogen sulfide gas removal material.

5. The oxygen gas sensing device of claim 3, wherein the hydrogen sulfide gas removal medium comprises a particulate hydrogen sulfide gas removal material disposed on at least one substrate selected from the group consisting of activated carbon, silica gel, porous plastic, and activated carbon cloth.

6. The oxygen gas sensing device of claim 1, wherein the filter portion comprises:
a filter housing defining the gas flow pathway; and
a hydrogen sulfide gas removal medium comprising copper compound-impregnated activated carbon cloth disposed in the gas flow pathway within the filter housing.

7. The oxygen gas sensing device of claim 6, wherein the hydrogen sulfide gas removal medium comprises at least two layers of copper compound-impregnated activated carbon cloth.

8. The oxygen gas sensing device of claim 7, wherein the hydrogen sulfide gas removal medium comprises at least two layers of copper oxide-impregnated activated carbon cloth.

9. The oxygen gas sensing device of claim 1, wherein the gas sensing portion includes a gas sensor housing holding the electrolyte, and further wherein the filter housing is secured to the gas sensor housing.

10. The oxygen gas sensing device of claim 9, wherein the filter housing is secured to the gas sensor housing by one of an adhesive and an adhesive tape.

11. The oxygen gas sensing device of claim 1, wherein the gas sensing portion includes a gas sensor housing holding the electrolyte, and wherein the gas sensor housing and the filter housing are portions of a single part.

12. A hydrogen sulfide tolerant electrochemical oxygen gas sensing device comprising:
a gas sensing portion including a sensor housing and a gas inlet, and wherein a sensing electrode, a counter electrode, and an electrolyte in contact with the sensing electrode and the counter electrode are disposed within the sensor housing; and
a filter portion including a filter housing and a porous hydrogen sulfide gas removal medium disposed in the filter housing portion, wherein the porous hydrogen sulfide gas removal medium comprises at least one hydrogen sulfide gas removal material selected from the group consisting of activated carbon, copper compounds, metal oxides, and alkaline materials, and wherein the filter housing portion is one of mounted to and integral with the sensor housing portion and defines a gas flow pathway that passes through the porous hydrogen sulfide gas removal medium to the gas inlet.

13. The oxygen gas sensing device of claim 12, wherein the hydrogen sulfide gas removal material is disposed on a substrate selected from activated carbon, silica gel, porous plastic, and carbon cloth.

14. The oxygen gas sensing device of claim 12, wherein the gas sensing device is a trace oxygen sensing device, and the hydrogen sulfide gas removal medium comprises at least one layer of copper oxide-impregnated carbon cloth.

15. An electrochemical oxygen gas sensing device comprising a housing defining a gas pathway through which gas to be sensed passes, the electrochemical oxygen gas sensing device comprising a hydrogen sulfide gas removal medium disposed in the gas pathway.

16. The electrochemical oxygen gas sensing device of claim 15, wherein the hydrogen sulfide gas removal medium is capable of removing substantially all hydrogen sulfide gas from the gas to be sensed.

17. The electrochemical oxygen gas sensing device of claim 15, further comprising a sensor housing and a filter housing, wherein the hydrogen sulfide filter is one of:
secured to the sensor housing; and
integral with the sensor housing such that the sensor housing and the filter housing are a single part.

18. A hydrogen sulfide gas filter adapted to be attached to an oxygen gas sensor so as to render the oxygen gas sensor tolerant to the presence of hydrogen sulfide gas in the gas stream to be sensed by the oxygen gas sensor.
